(19) United States
(12) Patent Application Publication
(10) Pub. No.: US 2017/0328842 A1
(43) Pub. Date: Nov. 16, 2017

(54) DEFECT OBSERVATION METHOD AND DEFECT OBSERVATION DEVICE

(71) Applicant: HITACHI HIGH-TECHNOLOGIES CORPORATION, Tokyo (JP)

(72) Inventors: Yuko Otani, Tokyo (JP); Yuji Takagi, Tokyo (JP); Hideki Nakayama, Tokyo (JP)

(73) Assignee: HITACHI HIGH-TECHNOLOGIES CORPORATION, Tokyo (JP)

(21) Appl. No.: 15/522,143

(22) PCT Filed: Dec. 1, 2015
(86) PCT No.: PCT/JP2015/083688

§ 371 Date: Apr. 26, 2017

(30) Foreign Application Priority Data
Dec. 3, 2014 (JP) 2014-245082

(51) Int. Cl. G01N 21/956; G01N 23/225

(52) U.S. Cl. CPC G01N 21/95607; G01N 23/2251; G01N 21/95623; G01N 2021/95615

(57) ABSTRACT

Provided are a defect observation method and a defect observation device which detect a defect from an image obtained by imaging the defect on a sample with an optical microscope by using positional information of the defect on the sample detected by a different inspection device to correct the positional information of the defect and observe in detail the defect on the sample with a scanning electron microscope using the corrected positional information. The defect observation method includes detecting the defect from the image to correct the positional information of the defect, switching a spatially-distributed optical element of a detection optical system of the optical microscope according to the defect to be detected, and changing an image acquisition condition for acquiring the image and an image processing condition for detecting the defect from the image according to a type of the switched spatially-distributed optical element.

### TECHNICAL FIELD

The present invention relates to a defect observation method and a defect detection device for observing defects and the like generated on a semiconductor wafer at a high speed and with a high resolution in a manufacturing process for a semiconductor device.

### BACKGROUND ART

In a process of manufacturing a semiconductor device, a pattern defect (hereinafter, referred to as a defect but including an extraneous substance or a pattern defect) such as short-circuit or disconnection existing on a semiconductor substrate (wafer) causes failure such insulation failure of wiring or a short circuit. In addition, with the miniaturization of circuit patterns formed on the wafer, miniaturized defects also cause insulation failure of capacitors and destruction of gate oxide films or the like. These defects are caused in various states by various causes such as defects generated from moving portions of a conveying device, defects generated from a human body, defects generated in reaction inside a processing device by a processing gas, and defects mixed in chemicals or materials. Therefore, detecting defects generated during the manufacturing process, quickly positioning the source of defects, and stopping the generation of defects are important for mass production of semiconductor devices.

In the related art, as a method of finding the cause of defect generation, there is a method of, first, specifying a defect position by a defect inspection device, observing and classifying the defect in detail by an SEM (Scanning Electron Microscope) or the like, and comparing with database to estimate the cause of defect generation.

As disclosed in, for example, Patent Document 1, in an device for observing defects in detail by an SEM, a position of a defect on a sample is detected by an optical microscope provided to an SEM defect observation device using positional information of the defect on the sample detected by a different defect inspection device, the positional information of the defect obtained through detection by the different inspection device is corrected, and after that, the defect is observed (reviewed) in detail by the SEM type defect observation device.

With the increase in integration density of semiconductor devices, a pattern formed on a wafer becomes further miniaturized, and defects which are fatal to semiconductor devices are miniaturized and small-sized. It is required to observe (review) in detail such miniaturized and small-sized defects detected by the defect inspection device with an SEM-type defect observation device without decreasing the throughput. In order to realize this requirement, it is necessary to detect the defects obtained through detection by a different defect inspection device at high speed with high accuracy by an optical microscope provided to an SEM-type defect observation device and to correct the positional information detected by the different defect inspection device.

As a technique for detecting such miniaturized and small-sized defects with high accuracy, for example, Patent Document 1 discloses a method of obtaining defect detection sensitivity higher than that of an optical microscope in the related art by using a filter having an anisotropic characteristic using using a difference in polarization intensity distribution of roughness scattered light between defects and a wafer surface.

### CITATION LIST

### Patent Document

Patent Document 1: JP 2011-106974 A

### SUMMARY OF THE INVENTION

### Problems to be Solved by the Invention

Patent Document 1 discloses a technique for detecting a defect obtained through detection by a different inspection device by an optical microscope provided to an SEM-type defect inspection device, correcting positional information of the defect, and after that, observing the defect in detail by the SEM-type defect observation device. The in-focus position derivation method of the optical microscope discloses a configuration of acquiring a maximum luminance value for each of acquired images by changing the height of the objective lens and setting the height of the objective lens at which the maximum luminance value in the image becomes the maximum value as an in-focus position.

In the related art, in a microscope system using a filter having an anisotropic optical characteristic as disclosed in the above-mentioned Patent Document 1, in the case where defocusing a defect image from an in-focus height by a filter, a change in defect image is different from the case of using no filter having an anisotropic optical characteristic. In addition, in the case of the system which derives the barycentric coordinates of the defect image as defect coordinates as disclosed in the above-mentioned Patent Document 1, if a filter having an anisotropic optical characteristic is used, due to a change in the anisotropic defect image in the defocusing, the defect coordinate derivation accuracy is degraded according to the defocusing. Therefore, in the case of using a filter having an anisotropic optical characteristic, in order to prevent degradation of defect coordinate derivation accuracy in the defocusing, high in-focus height derivation accuracy is required in comparison with the case of using a filter having an isotropic optical characteristic.

However, in order to obtain high in-focus height derivation accuracy in accordance with an anisotropic optical characteristic, it is necessary to reduce a change in height of the objective lens at the time of image acquisition and to increase the number of acquired images, or it is necessary to determine the likelihood of the derived in-focus image, so that more time is required.

The present invention is to solve the problems in the related art and to provide a defect observation method and a defect observation device using a defect coordinate derivation method capable of increasing defect detection throughput even in the case where a filter having an anisotropic optical characteristic is used.

### Solutions to Problems

In order to solve the above problems, according to the present invention, there is provided a defect observation method of detecting a defect from an image obtained by imaging the defect on a sample with an optical microscope by using positional information of the defect on the sample detected by a different inspection device to correct the positional information of the defect and observing in detail the defect on the sample with a scanning electron microscope (SEM) using the corrected positional information, the defect observation method including: detecting the defect from the image obtained by imaging the defect with the optical microscope to correct the positional information of the defect; switching a spatially-distributed optical element of a detection optical system of the optical microscope according to the defect to be detected; and changing an image acquisition condition for acquiring the image of the defect by imaging the defect with the optical microscope and an image processing condition for detecting the defect from the image obtained by imaging the defect with the optical microscope according to a type of the switched spatially-distributed optical element.

In addition, in order to solve the above problems, according to the present invention, there is provided a defect observation method of detecting a defect from an image obtained by imaging the defect on a sample with an optical microscope by using positional information of the defect on the sample detected by a different inspection device to correct the positional information of the defect and observing in detail the defect on the sample with a scanning electron microscope (SEM) using the corrected positional information of the defect, the defect observation method including: detecting the defect from the image obtained by imaging the defect with the optical microscope to correct the positional information of the defect; and performing correcting by using the positional information of the defect obtained by changing an image acquisition condition for acquiring a plurality of images having different focus positions acquired in order to align the focus position of the optical microscope to a surface of the sample and a defect coordinate derivation condition for obtaining coordinates of the defect from the image obtained by imaging the defect with the optical microscope according to an optical characteristic of a spatially-distributed optical element of an detection optical system of the optical microscope.

Furthermore, in order to solve the above problems, according to the present invention, there is provided a defect observation device including: an optical microscope unit configured to optically detect a defect on a sample by using positional information of the defect on the sample detected by a different inspection device; and a scanning microscope (SEM) unit configured to acquire a detailed image of the defect by using the positional information of the defect detected by the optical microscope unit, wherein the optical microscope unit includes: an illumination optical system unit configured to irradiate a defect on the sample with illumination light; a detection optical system unit including a spatially-distributed optical element imaging a surface of the sample irradiated with the illumination light by the illumination optical system unit; a condition setting unit configured to set an imaging condition for imaging the surface of the sample with the detection optical system and an image processing condition for processing an image of the surface of the sample obtained by imaging the surface of the sample with the detection optical system; and an image processing unit configured to process the image of the surface of the sample obtained by imaging by the detection optical system unit on the basis of the image processing condition set by the condition setting unit to detect a defect on the sample, and wherein the condition setting unit changes the condition for imaging the surface of the sample by the detection optical system unit and the image processing condition for processing the image of the surface of the sample by the image processing unit according to a type of the spatially-distributed optical element of the detection optical system unit.

### Effects of the Invention

According to the present invention, it is possible to suppress an increase in throughput while securing coordinate derivation accuracy required for defect detection using light, and it is possible to increase the throughput of detailed observation of defects using an SEM.

### BRIEF DESCRIPTION OF THE DRAWINGS

FIG. 1 is a block diagram illustrating an overall configuration of a defect observation device according to a first embodiment of the present invention.

FIG. 2A is a diagram illustrating a schematic configuration of an optical microscope unit of the defect observation device according to the first embodiment of the present invention.

FIG. 2B is a diagram illustrating a schematic configuration of a dark field illumination optical system of the optical microscope unit according to the first embodiment of the present invention.

FIG. 2C is a block diagram illustrating a schematic configuration of an optical microscope control unit in a control system unit of the defect observation device according to the first embodiment of the present invention.

FIG. 3A is a diagram illustrating an example of an image acquired by the optical microscope unit according to the first embodiment of the present invention, which is an example of a defect detection image corresponding to a focus position shift amount observed in the case where a filter having an isotropic optical characteristic is provided in a detection optical system.

FIG. 3B is a diagram illustrating an example of an image acquired by the optical microscope unit according to the first embodiment of the present invention, which is an example of a defect detection image corresponding to a focus position shift amount observed in the case where a filter having an anisotropic optical characteristic is provided in a detection optical system.

FIG. 3C is a graph illustrating the relationship between the focus position shift amount (change amount in the Z direction) and the coordinate accuracy of the image acquired by the optical microscope unit according to the first embodiment of the present invention.

FIG. 4 is a flowchart illustrating a flow of a defect observation process by a defect observation device according to the first embodiment of the present invention.

FIG. 5 is a flowchart illustrating a detailed process flow in S6003 and S6004 illustrated in FIG. 4 among the process flow of the optical microscope by the defect observation device according to the first embodiment of the present invention.

FIG. 6 is a flowchart illustrating a flow of a defect detection process using an optical microscope of a defect observation device according to a second embodiment of the present invention.

FIG. 7 is a flowchart illustrating a flow of a defect detection process using an optical microscope of a defect observation device according to a third embodiment of the present invention.

FIG. 8 is a front diagram of a screen illustrating an output example of the optical microscope unit according to the third embodiment of the present invention.

FIG. 9 is a flowchart illustrating a flow of a defect detection process using an optical microscope of a defect observation device according to a fourth embodiment of the present invention.

FIG. 10 is a block diagram illustrating an overall configuration of a defect observation device according to a fifth embodiment of the present invention.

### MODE FOR CARRYING OUT THE INVENTION

Hereinafter, embodiments of the present invention will be described with reference to the drawings.

### First Embodiment

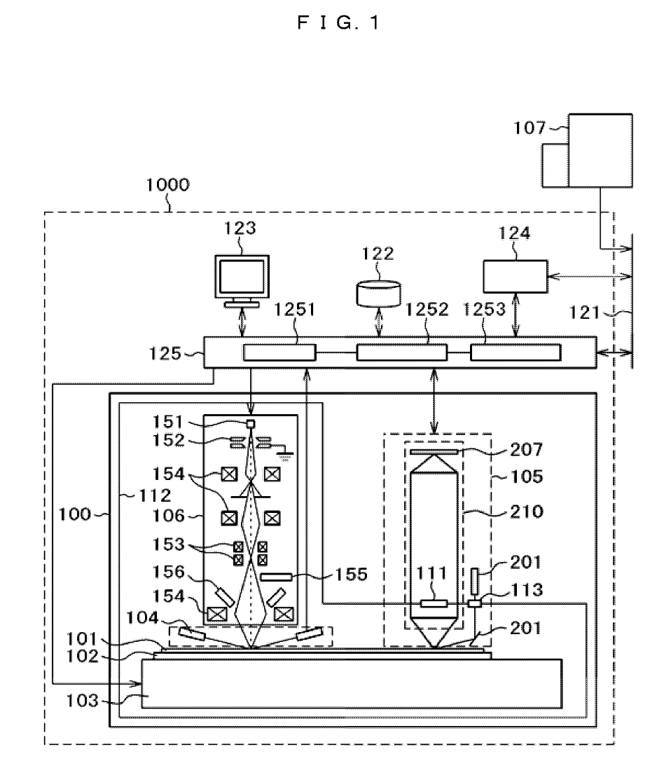

FIG. 1 is a diagram illustrating a configuration of a defect observation device according to a first embodiment of the present invention. The defect observation device 1000 is schematically configured to include a review device 100, a database 122, a user interface 123, a storage device 124, and a control system unit 125. In addition, the defect observation device 1000 is connected to a defect inspection device 107 which is another inspection device via the network 121.

The defect inspection device 107 detects defects existing on the sample 101 and acquires defect information such as position coordinates and sizes of defects. The defect inspection device 107 is only required to be able to acquire information on defects on the sample 101.

The defect information acquired by the defect inspection device 107 is input to the storage device 124 or the control system unit 125 via the network 121. The storage device 124 stores the defect information acquired by the defect inspection device 107 which is input via the network 121. The control system unit 125 reads the defect information which is input from the defect inspection device 107 or the defect information which is stored in the storage device 124 and controls the review device 100 on the basis of the read defect information. Then, some or all of the defects detected by the defect inspection device 107 are observed in detail, and classification of defects, analysis of the cause of occurrence, and the like are performed.

Next, the configuration of the review device 100 illustrated in FIG. 1 will be described.

The review device 100 is configured to include a driving unit including a sample holder 102 and a stage 103, an optical height detector 104, an optical microscope unit 105, a vacuum chamber 112, an SEM (Scanning Electron Microscope) 106 (electron microscope unit), and a laser displacement meter (not shown). The sample 101 is placed on a sample holder 102 installed on a movable stage 103. The stage 103 moves the sample 101 placed on the sample holder 102 between the optical microscope 105 and the SEM 106. According to the movement of the stage 103, the observation target defect existing on the sample 101 can be located within the field of view of the SEM 106 or within the field of view of the optical microscope 105.

The control system unit 125 is configured to include an SEM control unit 1251, an optical microscope control unit 1252, and an overall control unit 1253

and is connected to the stage 103, the optical height detector 104, the optical microscope unit 105, the SEM 106, the user interface 123, the database 122, and the storage device 124 to control the movement of the stage 103, the modulation of illumination state and the image acquisition of the optical microscope unit 105, the image acquisition by the electron microscope unit 106, the measurement by the measurement unit having the optical height detector 104, and the like and the operations and inputs of the components. Furthermore, the control system 125 is connected to an upper system (for example, the defect inspection device 107) via the network 121.

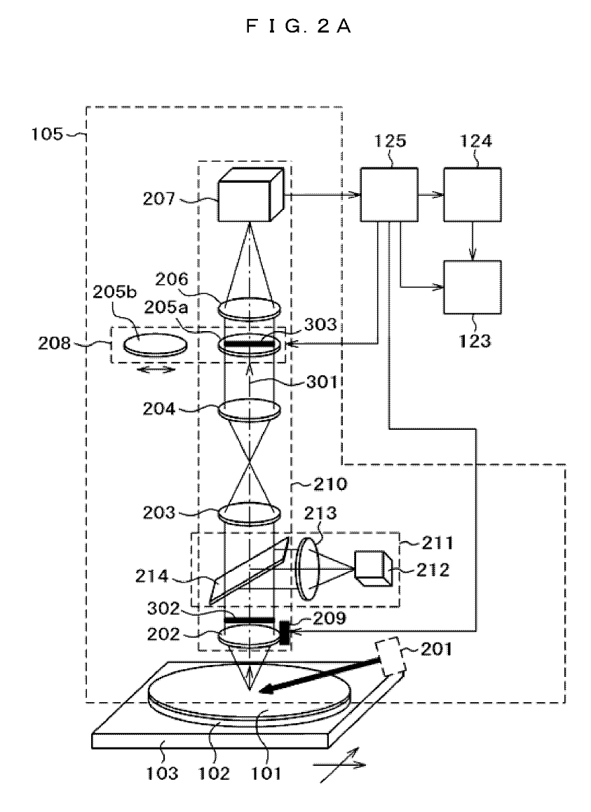

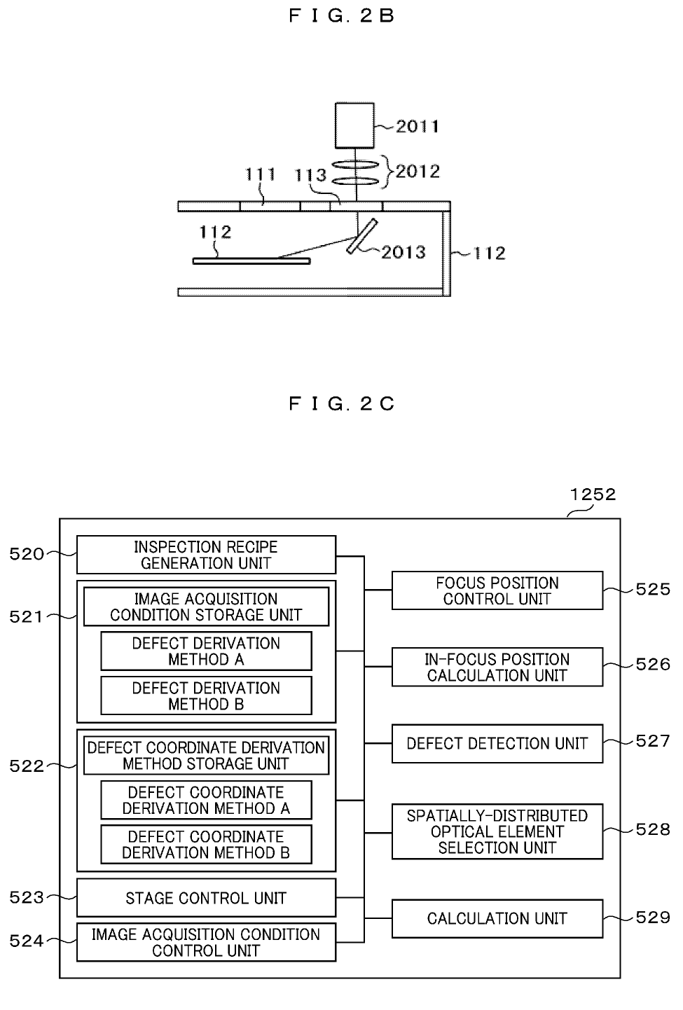

As illustrated in FIG. 2, the optical microscope 105 is configured to include a light illumination system 220 including a dark field illumination optical system 201 and a bright field illumination optical system 211 and a light detection system using a detection optical system 210. A portion of the optical microscope 105 (for example, the objective lens 202 and the like, refer to FIG. 2) is arranged inside the vacuum chamber 112 to guide light to the detector 207 through vacuum sealing windows 111 and 113 installed in the vacuum chamber 112.

The control system 125 reads the defect information outputted by the defect inspection device 107 or the defect information stored in the storage device 124, detects the defect again by using the image information obtained by controlling the optical microscope 105 on the basis of the read defect information, and outputs the positional information of the detected defect.

In addition, the control system 125 derives the defect coordinate shift between the defect inspection device 107 and the review device 100 on the basis of the defect information outputted by the defect inspection device 107 and the defect information detected by using the optical microscope 105 and corrects the positional information of the defect which is outputted from the inspection device 107 and stored in the storage device 124.

The SEM 106 is configured to include an electron beam irradiation system including an electron beam source 151, an extraction electrode 152, a converging lens 157, a deflection electrode 153, and an objective lens electrode 154, and an electron detection system including a secondary electron detector 155 and a reflected electron detector 156.

Primary electrons are emitted from the electron beam source 151 of the SEM 106, and the emitted primary electrons are extracted in a beam shape by the extraction electrode 152 to be accelerated. Then, after the beam system is allowed to converge and to be narrowed by the converging lens 157, the trajectory of the accelerated primary electron beam is controlled in the X direction and the Y direction by the deflection electrode 153, and the controlled primary electron beam of which the trajectory is controlled is allowed to converge on the surface of the sample 101 and is irradiated and scanned by the objective lens electrode 154.

Secondary electrons, reflected electrons, and the like are generated from the surface of the sample 101 scanned by irradiation with the primary electron beam. The secondary electron detector 155 detects the generated secondary electrons, and the reflected electron detector 156 detects relatively high energy electrons such as reflected electrons. A shutter (not shown) arranged on the optical axis of the SEM 106 selects start/stop of irradiation of the electron beam irradiated from the electron beam source 151 on the sample 101.

The configuration of the SEM 106 described above is controlled by the control system unit 125, and it is possible to change the electron beam focus and observation magnification. The SEM 106 reads the defect information outputted from the defect inspection device 107, the defect information outputted from the optical microscope 105, the defect information stored in the storage device 124, or the defect information corrected by the control system 125 and observes the defect in detail on the basis of the read defect information.

The optical height detector 104 measures a value corresponding to the displacement of the surface of the observation target area as the measurement unit of the review device 100. Here, the displacement includes various parameters such as the position of the observation target area, the amplitude, frequency, and period of the vibration. Specifically, the optical height detector 104 measures the height position of the surface of the observation target area of the sample 101 existing on the stage 103 and the vibration in the direction perpendicular to the surface of the observation target area. The displacement and vibration measured by the optical height detector 104 are output to the control system 125 as a signal.

On the basis of the defect information obtained by the defect inspection device 107, the control system unit 125 converts the positional information of the defect detected again by the optical microscope 105 and detected by the defect inspection device 107 into positional information on the review device. Namely, the SEM 106 uses the defect positional information on the review device converted from the defect positional information on the inspection device 107 in the control system unit 125 to observe the defect converted into the positional information on the review device by the control system unit 125.

FIG. 2A illustrates a configuration example of the optical microscope 105.

The optical microscope 105 is configured to include a dark field illumination optical system 201 having an illumination system 201, a light illumination system 220 having a bright field illumination optical system 211, and a detection optical system 210. In FIG. 2A, the notation of the vacuum chamber 112 and the vacuum sealing windows 111 and 113 is omitted.

As illustrated in FIG. 2B, the dark field illumination optical system 201 is configured to include an illumination light source 2011, a mirror 2013, a lens system 2012, and the like.

In the configuration of the dark field illumination optical system 201, the light (laser) 2015 emitted from the illumination light source 2011 is incident on the lens system 2012 to be condensed. The traveling direction thereof is controlled by being reflected by the mirror 2013 arranged inside the vacuum chamber 112 through the vacuum sealing window 113, and the light is condensed and irradiated on the surface of the sample 101. The lens system 2012 controls the beam diameter of the incident illumination light and condensing NA.

As illustrated in FIG. 2A, the bright field illumination optical system 211 is configured to include a white light source 212, an illumination lens 213, a half mirror 214, and an objective lens 202.

In this bright field illumination optical system 211, the white illumination light emitted from the white light source 212 is converted into parallel light by the illumination lens 213. A half of the incident light as the parallel light is folded into a direction parallel to the optical axis of the detection optical system 210 by the half mirror 214 and is condensed and irradiated on the observation target area by the objective lens 202. Instead of the half mirror 214, a dichroic mirror capable of transmitting more scattered light to the detector 207 may be used. Furthermore, in order to allow more scattered light to reach the detector 207, in the case where the bright field illumination optical system 211 is not used, the half mirror 214 may be configured to be movable so as to be removed from the optical axis 301.

As illustrated in FIG. 2A, the detection optical system 210 is configured to include an objective lens 202, lens systems 203 and 204, a spatially-distributed optical element 205, an imaging lens 206, and a detector 207.

In the detection optical system 210 having such a configuration, the scattered light and the reflected light generated from the region irradiated with the illumination light on the sample 101 by the illumination of the dark field illumination optical system 201 or the bright field illumination optical system 211 are captured by the objective lens 202. The captured light is image-formed on the detector 207 by the lens systems 203 and 204 and the imaging lens 206. The detector 207 converts the image-formed light into an electric signal and outputs the electric signal to the control system unit 125. The signal processed by the control system unit 125 is stored in the storage device 124. The process result or the stored process result is displayed by the user interface 123.

Furthermore, by the spatially-distributed optical element 205 arranged on a pupil plane 302 of the detection optical system 210 or on a pupil plane image 303 formed by the lens systems 203 and 204, the light to be detected by the detector 207 is selected from the light captured by the objective lens 202, and the polarization direction thereof is controlled. In addition, a switching mechanism 208 arranges the spatially-distributed optical element 205 appropriate for the target defect detection from a plurality of the spatially-distributed optical elements 205a and 205b having different optical characteristics on the optical axis 301 of the detection optical system 210.

The spatially-distributed optical element 205 may not necessarily be arranged on the optical axis 301. In this case, a dummy substrate (not shown) that changes the optical path length to the same length as that of the optical element 205 is arranged on the optical axis 301. The switching mechanism 208 is also capable of switching between the optical element 205 and the dummy substrate. For example, in the case of performing the bright field observation or in the case where there is no optical element 205 appropriate for the observation target, since the refractive index is different from the refractive index of the optical path passing through the medium of the optical element 205 in the case of using the optical element 205, there is a problem in that the acquired image of 207 is disturbed. Therefore, in the case where the optical element 205 is not used, a dummy substrate made of the same material as the optical element 205 may be arranged on the optical axis 301. Details of the optical element 205 are described in Patent Document 1.

As illustrated in FIG. 2C, the optical microscope control unit 1252 of the control system 125 is configured to include an inspection recipe generation unit 520, an image acquisition condition storage unit 521, a defect coordinate derivation method storage unit 522, a stage control unit 523, an image acquisition control unit 524, a focus position control unit 525, an in-focus position calculation unit 526, a defect detection unit 527, a spatially-distributed optical element selection unit 528 and a calculation unit 529.

The spatially-distributed optical element selection unit 529 selects the spatially-distributed optical element 205a or 205b appropriate for detecting the target defect from the output of the user interface 123 or the defect inspection device 107 and performs switching the spatially-distributed optical element 205. Furthermore, the optical microscope control unit 1252 controls a height control mechanism 209 by the focus position control unit 525 and aligns the focus position of the detection optical system 210 to the observation target area on the sample 101. As the height control mechanism 209, any one of a linear stage, an ultrasonic motor, a piezo stage, and the like is used. As the detector 207, any one of a two-dimensional CCD sensor, a line CCD sensor, a TDI sensor group in which a plurality of TDIs are arranged in parallel, a photodiode array, and the like is used. In addition, the detector 207 is arranged so that the sensor surface of the detector 207 is conjugate with the surface of the sample 101 or the pupil plane of the objective lens.

Next, an outline of a flow from defect detection by the defect inspection device 107 which is another inspection device to defect observation by the defect observation device 1000 will be described. First, a defect of the sample 101 is detected by using a defect inspection device 107 which is another inspection device, and defect information is output to the storage device 124 or the control system unit 125. The defect information of the sample 101 outputted by the defect inspection device 107 includes any one of defect coordinates (the coordinates of the chip where a defect is detected and position coordinates of the defect in the chip) detected by using the defect inspection device 107, a defect signal, a defect shape, polarization of defect scattered light, a defect type, a defect label, a feature quantity of the defect, a scattering signal of the surface of the sample 101, or a defect inspection result configured with a combination thereof and any one of an illumination incident angle an illumination wavelength, an illumination azimuth angle, an illumination intensity, and illumination polarization of the defect inspection device 107, an azimuth angle/elevation angle of the detector 207, a detection region of the detector 207 or the like, or a combination thereof. In the case where information on a plurality of the detectors exists in the defect information obtained by the defect inspection device 107, defect information of the sample 101 output for each sensor or defect information of the sample 101 obtained by integrating a plurality of sensor outputs is used.

Then, some or all of the defects detected by the defect inspection device 107 are observed by the review device 100. At this time, on the basis of the positional information of the defect acquired by the defect inspection device 107, the optical microscope control unit 1252 controls the optical microscope 105 to detect a defect again and converts a defect signal into positional information on the review device 100. Then, by using the converted positional information, the stage 103 is moved to position the observation target defect within the observation field of view of the SEM 106. After that, the SEM control unit 1251 controls the SEM 106 so that the electron beam focus of the SEM 106 is focused, and the defect is observed with the SEM 106. In addition, if necessary, defect image acquisition and defect classification are performed at an appropriate time by the SEM 106. In addition, if necessary, before performing the observation by the SEM 106 focusing of the electron beam focus may be performed by using the SEM image. By using this method, it is possible to increase the accuracy of focusing of the electron beam focus of the SEM 106 and thus, it is possible to observe the defect in more detail.

With the requirement for high integration of semiconductor devices, the defect size critical for semiconductor devices has been miniaturized. Therefore, the observation target defect of the review device 100 is miniaturized, and thus, it is necessary to observe and capture minute defects with high magnification. In addition, in the case where the review device 100 is used for in-line inspection in semiconductor manufacturing, shortening the observation time reduces a tact time. Furthermore, users of the review device 100 require increasing the speed of observation and imaging of high-resolution and high-magnification defects by using an SEM.

In order to cope with miniaturization of the observation target defect by the review device 100, it is necessary to miniaturize the minimum defect size detectable by the optical microscope 105. In order to cope with this requirement, in the optical microscope 105, improving the defect sensitivity is performed by increasing the NA (Numerical Aperture) of the detection lens, filtering of removing the roughness scattered light on the Fourier transform plane of the detection optical system and selectively passing the defect scattered light, or the like. However, with the high NA of the detection optical system, as expressed in (Mathematical Formula 1), since the depth of field (DOF) is decreased, high in-focus position derivation accuracy is required.

$$\begin{matrix}[ Mathematical Formula 1 ] & \\ 1 \\ DOF ∝ \frac{λ}{{NA}^{2}} & ( 1 ) \\ Mathematical Formula 1 & \\ ( Mathematical Formula 1 ) & \end{matrix}$$

In addition, with the miniaturization of defects to be observed, high coordinate derivation accuracy is required. For example, in order to automatically detect the defects having a diameter of 10 nm, is considered a case where five or more pixels are required on an SEM image obtained by imaging with an SEM. In order to automatically detect the defects by the SEM, the defect image needs to have an area of several pixels in the SEM image. This is because it is difficult to discriminate from noise with 1 pixel. In the case where 1 pixel ≧2 nm and, thus, the SEM image has 512 pixels, the field of view is 1.2 μm or less, and even in the case where the SEM image has 1064 pixels, the field of view is 2.4 μm or less. In the case of imaging defects having a diameter of 100 nm with 5 pixels on the SEM image, the field of view is 12 μm or less at 512 pixels, and the field of view is 24 μm or less at 1064 pixels. Although the Pixel number of the defect image in the SEM image can be increased by increasing the resolution of the SEM image, in order to secure a sufficient signal that can be distinguished from noise, it is necessary to decrease the scanning speed of the electron beam. As a result, the throughput is decreased. For this reason, the field of view of the SEM cannot be enlarged so much, and thus, high coordinate derivation accuracy is required for the optical microscope.

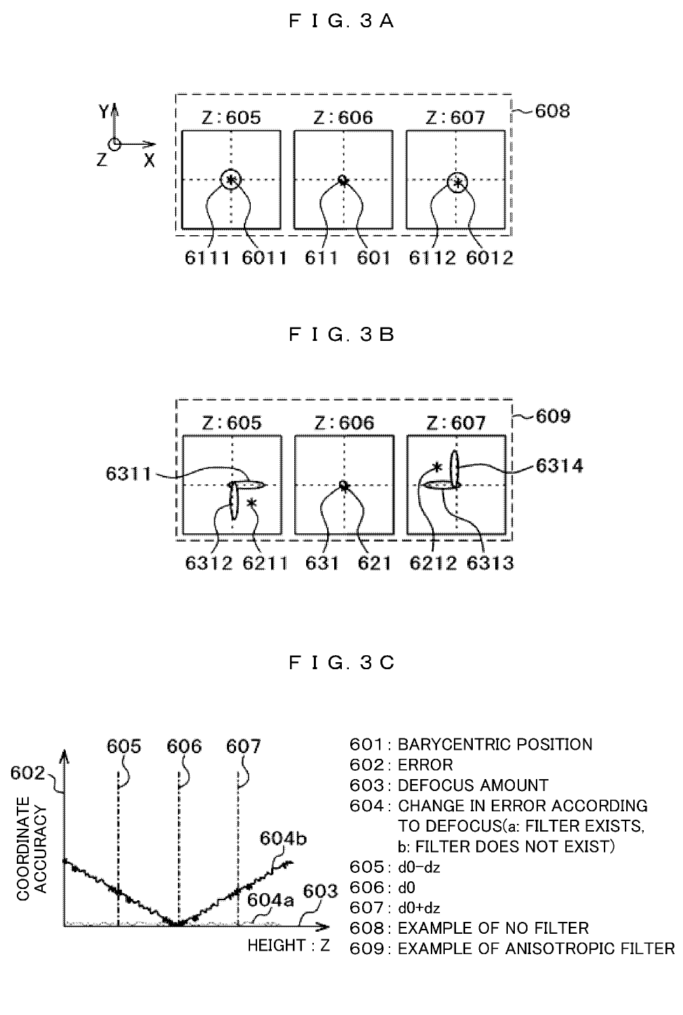

FIGS. 3A and 3B illustrate an example of a change in the defect image in defocusing and a change in the barycentric position of defect image. In FIG. 3A, reference numeral 608 denotes a defect image group imaged by using a filter having an isotropic optical characteristic.

In FIG. 3B, reference numeral 609 denotes a defect image group imaged by using a filter having an anisotropic optical characteristic. With respect to 608 of FIG. 3A and 609 of FIG. 3B, Z:606 indicates the in-focus position (Z0), Z:605 indicates the defocused height (Z0−dz) in the minus direction from the in-focus position, Z:607 indicates the defocused height (Z0+dz) in the plus direction from the in-focus position. The point 601 in FIG. 3A and the point 621 in FIG. 3B indicate the barycentric position of the defect image.

The axis 603 in the graph of FIG. 3C represents the relative distance (height Z of the detection optical system) between the detection optical system of the optical microscope and the sample 101, and the axis 602 represents the defect coordinate accuracy (the distance between the true defect coordinates and the barycentric coordinates 601).

In the filter having the isotropic optical characteristic, as indicated by 608 in FIG. 3A, with respect to the change of the images 6111 and 6112 in the defocusing as indicated by Z:605 and Z:607, in the case where there is no aberration distorting the image anisotropically such as coma, since the image spreads almost isotropically, the barycentric coordinates are detected at the position 6011 at Z:605 and detected at the position 6012 at Z:607. If the change in the barycentric position of the defect image with respect to the shift amount in the Z direction is plotted in the graph of FIG. 3C, the defect coordinate accuracy changes like a line 604a.

On the other hand, in the filter having an anisotropic optical characteristic, as indicated by 609 in FIG. 3B, the image of the defect is detected as a point image 631 in the state where Z:606 is focused, the barycentric coordinate 621 is detected as an almost center of the point image 631. On the other hand, as illustrated in defect images 6311 and 6312 of Z:605 and defect images 6313 and 6314 of Z:607 due to the defocusing, the defect image is anisotropically changed, so that the barycentric coordinates of the defect calculated from each image is detected at the position of 6211 from the image of Z:605 and at the position of 6212 from the image of Z:607, and the defect coordinate accuracy in the graph illustrated in FIG. 3C is degraded due to the defocusing as indicated by a line 604b with respect to a change in the height direction Z of the detection optical system. Therefore, it can be understood that, in order to accurately obtain the center position of the defect image in the case where a filter having an anisotropic optical characteristic is used, it is required to use an image with a small focus shift in calculation of the center position of the defect image, and higher in-focus position derivation accuracy is required.

As the filter having an isotropic optical characteristic used in the case of FIG. 3A, not only a polarizer and a color filter having uniform optical characteristic in a plane but also a case where there is no filter (dummy glass) are included. On the other hand, as the filter having an anisotropic optical characteristic used in the case of FIG. 3B, a spatial filter for masking back scattering to remove roughness scattered light strongly scattered backward, a pupil filter including an anisotropic spatial filter are exemplified.

In this embodiment, in order to solve the problem that high in-focus position derivation accuracy is required in the case of using the filter having an anisotropic optical characteristic described above, the image acquisition condition, the in-focus position derivation method, and the defect coordinate derivation method are determined and switched according to the detection condition. The detection condition is, for example, a filter condition or the like.

The image acquisition condition is for example, as a condition for deriving the in-focus position, a height shift amount of 1 STEP in the case where, under the control of the focus position control unit 525, a distance between the focus position of the illumination optical system and the sample 101 (hereinafter, referred to as a height) is shifted by 1 STEP in height and a plurality of images is obtained or the number of images to be acquired or the image acquisition range under the control of the image acquisition control unit 524.

The defect coordinate derivation method is a method of the in-focus position calculation unit 526 deriving the in-focus position (Z_{af}) from a plurality of acquired images, deriving Z_{af} under the control of the focus position control unit 525, deriving an image again under the control of the image acquisition control unit 524, and deriving the defect coordinates by using the image acquired by the defect detection unit 527 or a method of the in-focus position calculation unit 526 deriving defect coordinates by using a plurality of images acquired according to the image acquisition condition s without acquiring the image again at the height Z_{af}. For example, in the case of acquiring the in-focus image again, the acquired in-focus image can be binarized with a luminance value, and thus, a defect region can be extracted. In addition, the barycentric position of the extracted defect region can be used as defect coordinates. In addition, in the case where the in-focus image is not acquired anymore, the defect detection unit 527 binarizes each image of the plurality of images acquired with the luminance value in advance, derives a change in the barycentric coordinates due to the height, and calculates the distance between the defect area and the barycentric coordinate. The in-focus position (Z_{af}) can be derived from the in-focus position calculation unit 526, and the defect coordinates can be derived in the defect detection unit 527 from the number of defect areas.

Thus, in an optical microscope using a filter having an anisotropic optical characteristic with high defect detection sensitivity, it is possible to secure high coordinate derivation accuracy and to shorten defect detection time under detection conditions of an isotropic optical characteristic. As a result, according to this embodiment, it is possible to realize high sensitivity and high throughput for a review device provided with an optical microscope.

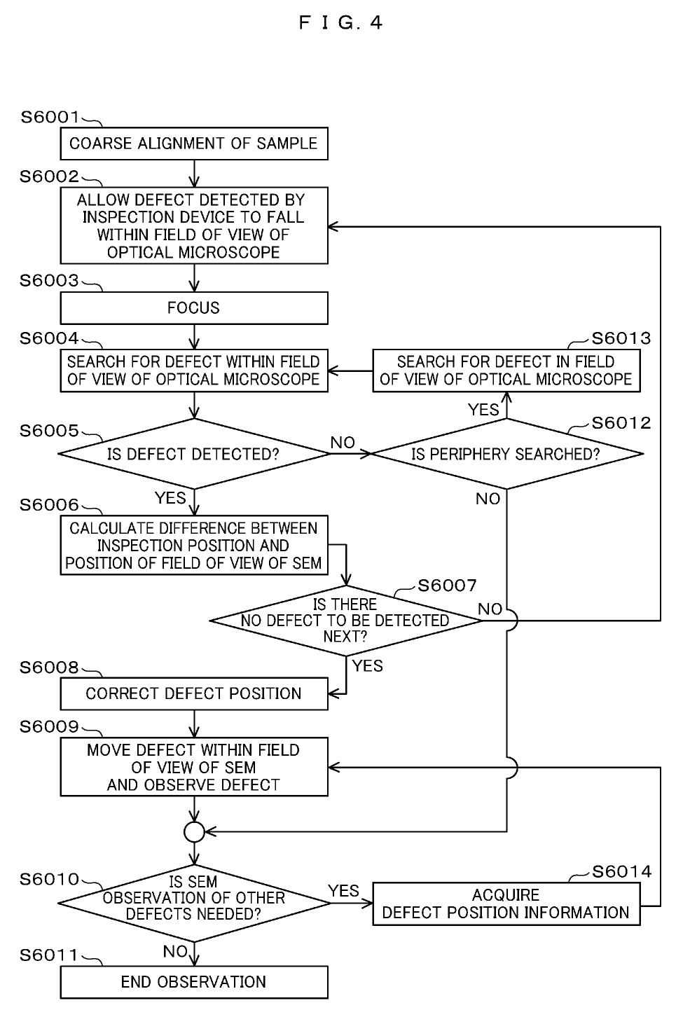

FIG. 4 illustrates a flowchart up to defect observation according to the first embodiment.

First, the control system unit 125 reads out the defect information of the sample 101 that is outputted by the external inspection device 107 and stored in the storage device 124, and under the control of the control system unit 125, the review device 100 perform the defect observation on the basis of the defect information. In this defect observation, firstly, under the control of the optical microscope control unit 1252, the sample 101 is illuminated by the bright field illumination optical system 211 of the optical microscope 105 to perform bright field observation by the detection optical system 210 or coarse alignment of the sample 101 by other microscope for alignment (S6001). Next, the stage control unit 523 controls the stage 103 on the basis of the defect information of the sample 101 that is output by the external inspection device 107 and read by the control system unit 125, and thus, the stage 103 is moved so that the observation target defect enters the field of view of the optical microscope 105 (S6002). The focus position control unit 525 controls the height control mechanism 209 to move the objective lens 202 of the optical microscope 105 so that the optical microscope 105 is focused on the sample 101 (S6003).

Then, the image acquisition control unit 524 controls the optical microscope 105 to acquire an image around the observation target area and searches for observation target defects from the image acquired by the defect detection unit 527 (S6004). In the case where the observation target defect is detected by the defect search in this acquired image (YES in S6005), the coordinates of the defect detected by the defect detection unit 527 are obtained, and the calculation unit 528 calculates a shift between the defect detection position by the optical microscope 105 and the defect position detected by the inspection device 107 (S6006).

On the other hand, in the case where the defect detection unit 527 cannot detect the observation target defect on the basis of the acquired image (NO in S6005), it is considered that the defect exists outside the field of view of the optical microscope 105, so that the peripheral portion of the field of view in the imaging region may be imaged by the optical microscope 105 and, thus, the observation target defect may be searched for. In the case of imaging the peripheral portion of the field of view (YES in S6012), the stage control unit 523 controls the stage 103 to move the stage 103 by an amount corresponding to the field of view of the optical microscope 105 (S6013). The process returns to the procedure for detecting defects by the above-described optical microscope 105 (S6004), and the process proceeds.

In the case where there is no defect to be detected next by the optical microscope 105 (YES in S6007),

the position coordinates of the observation target defect of the sample 101 that are output by the external inspection device 107 and read by the control system unit 125 are converted into position coordinates on the review device on the basis of the difference calculated in S6006 (S6008). The stage 103 is moved so that the observation target defect falls within the field of view of the SEM 106, and the electron beam is focused on the sample 101 by controlling the SEM control unit 1251. After that, an SEM image is acquired (S6009). On the other hand, in the case where there is a defect to be detected next (NO in S6007), the process returns to the procedure (S6002) for detecting the defect by the optical microscope 105 in the review device 100 described above, and the processes from S6002 to S6005 for the defect to be detected next proceed.

Next, after acquiring the SEM image of the defect in S6010, the control system unit 125 determines whether or not there is a defect to be observed next (S6010). In the case where there is a defect to be observed next (YES in S6010), the position information of the defect to be observed next which is corrected in S6008 is acquired (S6014). The process returns to the procedure (S6009) of observing defects by the above-described review device 100, and the process proceeds. On the other hand, in the case where there is no defect to be observed next (NO in S6010), the observation by the review device 100 is ended (S6011).

FIG. 4 illustrates a flow in which, in the case where there are a plurality of the observation target defects, all the coordinates of the observation target defects are obtained by using the optical microscope 105, and after that, the defects of which the coordinates are derived are observed by the SEM 106. Alternatively, with respect to one observation target defect, the coordinates are derived by using the optical microscope 105, and observation is performed by using the SEM 106; and after that, with respect to the next observation target defect, the coordinates are derived by using the optical microscope, and these processes may be sequentially repeated.

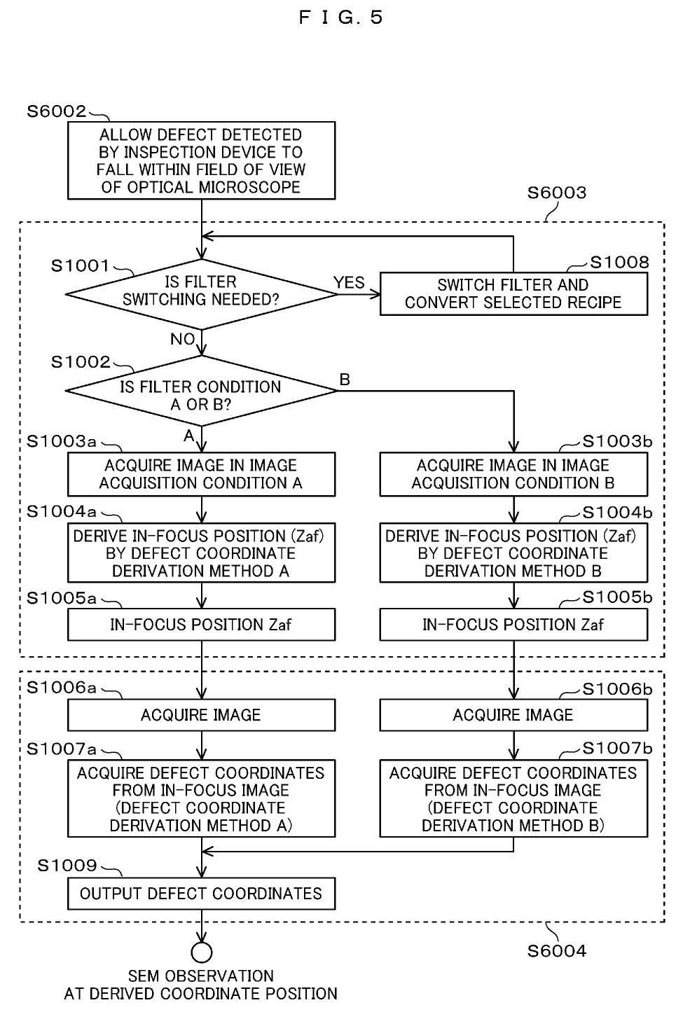

FIG. 5 illustrates a detailed flowchart of a process (S6003) of focusing and a process (S6004) of searching for a defect within the field of view of the optical microscope 105 in the flowchart up to defect detection by the optical microscope 105 in the review device 100 in the first embodiment.

After the defect detected by the inspection device 107 is moved into the field of view of the optical microscope 105 in S6002, it is determined whether the switching of the filter (spatially-distributed optical element 205) by the spatially-distributed optical element selection unit 529 is necessary (S1001). In the case where the switching of the filter is necessary (YES in S1001), the switching mechanism 208 switches the filter (spatially-distributed optical element 205a or 205b) according to a command signal from the spatially-distributed optical element selection unit 529, and an inspection recipe selection unit 520, selects an optical inspection recipe corresponding to the switched filter (S1008). In the case where the switching of the filter is unnecessary (NO in S1001), the following process proceeds according to the selected filter.

First, the focus position control unit 525 determines whether the filter condition is “A” or “B” (S1002). In the case where it is determined that the filter condition is “A” (in the case of “A” in S1002), under the control of the focus position control unit 525, the focus position of the illumination optical system is sequentially shifted by a predetermined height shift amount on the basis of the image acquisition condition “A” stored in the image acquisition condition storage unit 521, and under the control of the image acquisition control unit 524, imaging is performed, so that a predetermined number of images are acquired (S1003a). Next, the in-focus position calculation unit 526 derives the in-focus position (Z_{af}) from a plurality of the acquired images by using the focus position derivation method of the defect coordinate derivation method “A” stored in the defect coordinate derivation method storage unit 522 (S1004a). Next, under the control of the focus position control unit 525, the distance between the objective lens and the sample is aligned to the derived in-focus position (S1005a), and under control of the image acquisition control unit 524, the in-focus image is acquired (S1006a). The defect detection unit 527 calculates the defect coordinates from the acquired in-focus image by using the defect coordinate derivation method “A” stored in the defect coordinate derivation method storage unit 521 (S1007a). Finally, the acquired defect coordinates and in-focus image are output (S1009), and the following process proceeds.

On the other hand, in the case where it is determined in the filter condition determination (S1002) by the focus position control unit 525 that the filter condition is the filter “B” (in the case of “B” in S1002), the inspection recipe selection unit selects the inspection recipe corresponding to the filter “B”. Next, under the control of the focus position control unit 525,

the focus position of the illumination optical system is sequentially shifted by a predetermined height shift amount on the basis of the image acquisition condition “B” stored in the image acquisition condition storage unit 521, and under the control of the image acquisition control unit 524, imaging is performed, so that a predetermined number of images are acquired (S1003b). Next, the in-focus position calculation unit 526 derives the in-focus position (Z_{af}) from a plurality of the acquired images by using the in-focus position derivation method of the defect coordinate derivation method “B” stored in the defect coordinate derivation method storage unit 522 (S1004b). Next, under the control of the focus position control unit 525, the distance between the objective lens and the sample is aligned to the derived in-focus position (S1005b), and under the control of the image acquisition control unit 524, the in-focus image is acquired (S1006b). The defect detection unit 527 calculates defect coordinates from the acquired in-focus image by using the defect coordinate derivation method “B” stored in the defect coordinate derivation method storage unit 521 (S1007b). Finally, the acquired defect coordinates and the in-focus image are output (S1009).

Among the steps described above, the steps of from S1001 to S1005a and S1005b correspond to S6003 of the process of FIG. 4, and the steps of from S1006a and S1006b to S1009 correspond to S6004 of the process of FIG. 4.

In the process flow illustrated in FIGS. 5, S6002 and S1001 may be reversed. Specifically, after selecting the filter (S1001), the defect may be moved into the field of view of the optical microscope (S6002).

Furthermore, at the time of deriving the in-focus position (Z_{af}) by the in-focus position calculation unit 526 in S1004a or S1004b, in the case where the reliability of the focusing measure obtained from the acquired image is low or monotonously decreasing or monotonously increasing, namely, in the case where it is determined that the in-focus position exists outside the range of the acquired image, the image acquisition range is changed, the process returns to step S1003a or S1003b, and the following process proceeds. For example, in the case where the reliability of the focusing measure is low, the center height the image acquisition range is unchanged, and the image acquisition range is expanded. Furthermore, in the case where the reliability of the focusing measure is monotonously decreasing or monotonously increasing, it is considered that the image acquisition range is shifted in the direction of increasing the focusing measure (the direction in which the focus exists).

In the process flow described with reference to FIG. 5, it is assumed that the filter condition “A” corresponds to the case of using a filter having an isotropic optical characteristic, and the filter condition “B” corresponds to the case of using a filter having an anisotropic optical characteristic. At this time, the relationship between the image acquired under the filter condition “A” and the focus position shift in S1003a is indicated like a line 604a in FIG. 3A or FIG. 3C. In this case, since the in-focus position (focus position) can be obtained with relatively high accuracy by using a relatively small number of images with different focus position shift amounts in S1004a, the number of images acquired in S1003a is smaller, and thus, the time required for the image acquisition can be shortened.

On the other hand, the relationship between the image acquired by the defect coordinate derivation method “B” and the focus position shift in S1003b is indicated like a line 604b in FIG. 3B or FIG. 3C. In this case, in S1004b, the in-focus position can be obtained by using images having a relatively large number of focus position shift amounts in comparison with the case of S1003a. As a result, the time required for the image acquisition in S1003b is somewhat longer than that in S1003a. However, it is possible to obtain the in-focus position with relatively high accuracy. As a result, after aligning the focus position with relatively high accuracy in S1005b, it is possible to acquire an image of which focus position is aligned in S1006b, and it is possible to read the position (coordinates) of the defect from the image having the focus position in S1007b with high accuracy by using the defect coordinate derivation method “B”.

According to this embodiment, the review device can be provided with an optical microscope for selecting the image acquisition method and the defect coordinate derivation method set for each filter condition in the review device, so that it is possible to realize high sensitivity and high throughput.

According to this embodiment, since the image acquisition method and the defect coordinate derivation method are different for each filter condition, the SEM observation time of the same sample varies depending on the filter condition.

### Second Embodiment

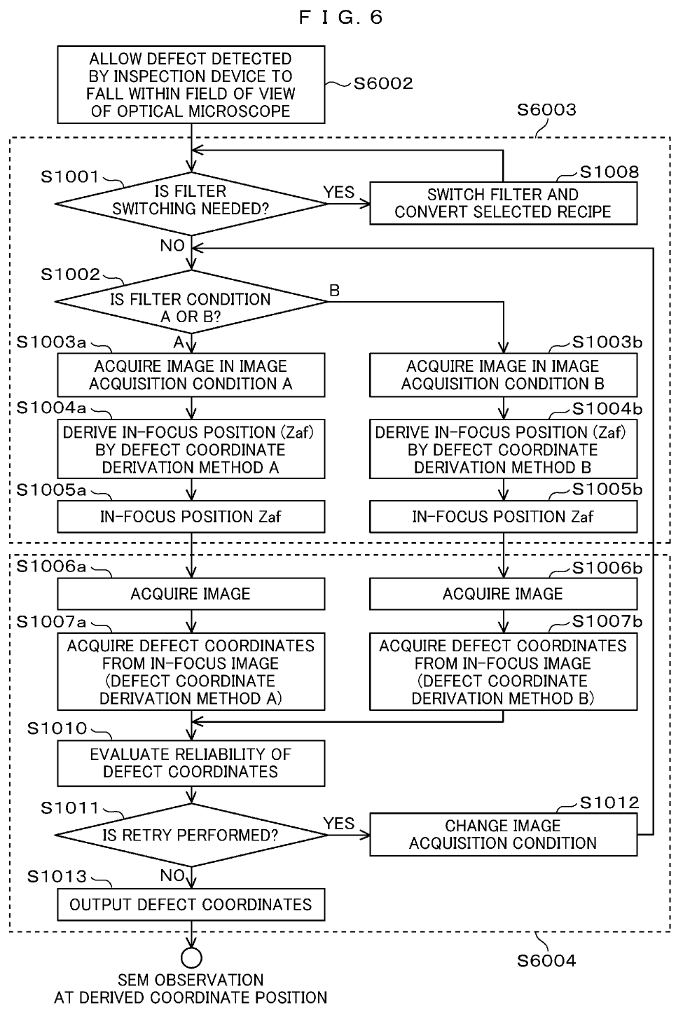

Next, a second embodiment according to the present invention will be described. In this embodiment, the configuration of a review device is the same as that described with reference to FIGS. 1 and 2 in first embodiment, and thus, the description of the configuration of the device will be omitted. This embodiment is different from the first embodiment in that the reliability of whether derived coordinates are defect coordinates is evaluated. Hereinafter, operations different from the operations described in the first embodiment will be described. FIG. 6 is a flowchart up to defect detection by the optical microscope in the review device in the second embodiment and corresponds to the flowchart described with reference to FIG. 5 in the first embodiment. Steps of from S1001 to S1007a and S1007b and S1008 in the flowchart illustrated in FIG. 6 are the same as those described in FIG. 5. The configuration of the review device in this embodiment will be described with reference to FIGS. 1 and 2.

In S1007a or S1007b, an image is acquired under an image acquisition condition selected by a filter condition, an in-focus position (Z_{af}) is derived from the acquired image, an image is acquired at the derived in-focus position Z_{af}, and defect coordinates are derived from the acquired image. However, in this embodiment, at this time, the likelihood (reliability) that the derived defect coordinates are defects is evaluated (S1010). In the case where the likelihood is low, retry is performed (YES in S1011), and the image acquisition condition is changed (S1012). The process returns to S1002, and the process proceeds as follows. In the case where it is determined that the likelihood is so sufficient that it is not necessary to perform retry (NO in S1011), defect coordinates of the determined defect are output (S1013).

Among the steps described in FIG. 6, steps of from S1001 to S1005a and S1005b and S1008 correspond to S6003 of the process of FIG. 4, and the steps of from S1006a and S1006b to S1013 correspond to S6004 of the process of FIG. 4.

The likelihood that the derived defect coordinates are defects can be determined, for example, according to whether or not the derived defect coordinates are within the defect region obtained from the in-focus image or whether or not the ratio of the luminance value of the defect coordinates to the maximum luminance value in the focused image is equal to or greater than the threshold value.

According to this embodiment, it is possible to increase the reliability of the derived defect coordinates and to improve the defect observation success rate by the SEM.

### Third Embodiment

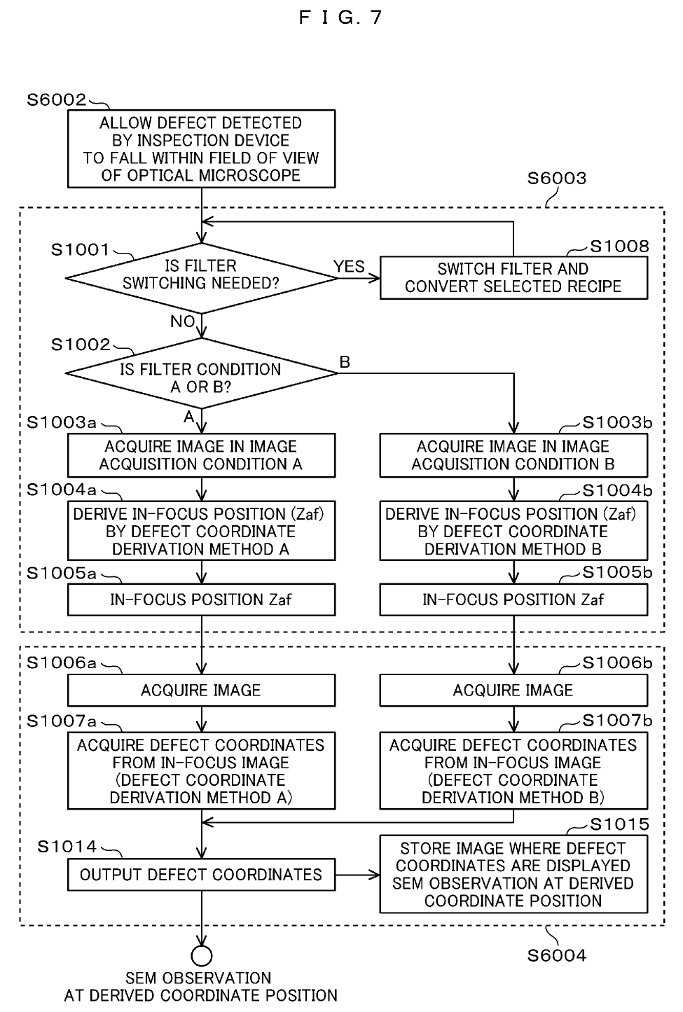

Next, a third embodiment will be described, the third embodiment is different from the first embodiment in that an image superimposed on the in-focus image obtained by acquiring derived defect coordinates with a height Z_{af} is outputted and stored. Hereinafter, operations different from the operations described in the first embodiment will be described. FIG. 7 is a flowchart up to defect detection by the optical microscope in the review device in the third embodiment and corresponds to the flowchart described with reference to FIG. 5 in the first embodiment. The processes from S1001 to S1007a, S1007b and S1008 of the flowchart illustrated in FIG. 7 are the same as those described with reference to FIG. 5. In this embodiment, the configuration of an optical microscope is basically the same as that described with reference to FIG. 2 in the first embodiment, and thus, the description of the configuration of the device will be omitted.

In this embodiment, for example, in the case where ADR fails, it is checked whether or not there is a problem with the defect coordinates derived by using the optical microscope. If there is a problem, the image acquisition condition and the defect coordinate derivation method are corrected to be introduced for the purpose of improving the defect coordinate derivation accuracy.

In FIG. 7, after acquiring the defect coordinates from the in-focus image in S1007a or S1007b, in the step of outputting defect coordinates (S1014), an image where defect coordinates are superimposed and displayed on the image acquired at the in-focus position is stored in the storage device 124 (S1015).

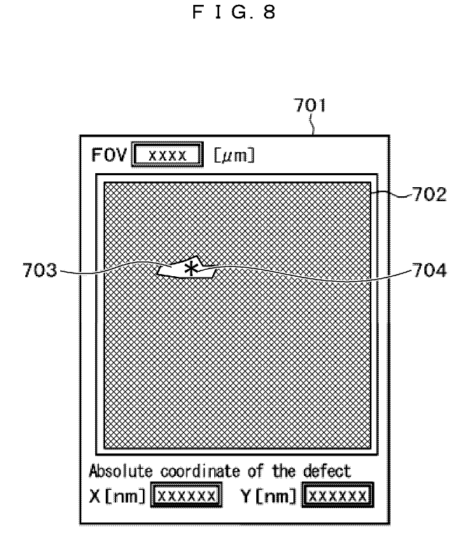

An example in which defect coordinates are displayed on the screen 701 of the user interface 123 will be described with reference to FIG. 8. On the screen 701,

a point 704 displaying the defect coordinates derived by the defect coordinate derivation method is superimposed and displayed on the in-focus image 702 acquired by the optical microscope unit 105. For example, as illustrated in FIG. 8, if the defect image 703 and the point 704 indicating the defect coordinates derived are superimposed, it is understood that probable defect coordinates are derived. In the case where the point 704 indicating the defect coordinates derived from the defect image 703 is shifted, it is necessary to correct the image acquisition condition or the defect coordinate derivation method.

Among the steps described in FIG. 7, the steps of from S1001 to S1005a and S1005b and S1008 correspond to S6003 of the process of FIG. 4, and the steps of from S1006a and S1006b to S1015 correspond to S6004 of the process of FIG. 4.

In this method, since the result of deriving the defect coordinates can be visually checked on the screen, it is possible to increase the accuracy of deriving defect coordinates, and it is possible to improve the defect observation success rate by the SEM.

### Fourth Embodiment

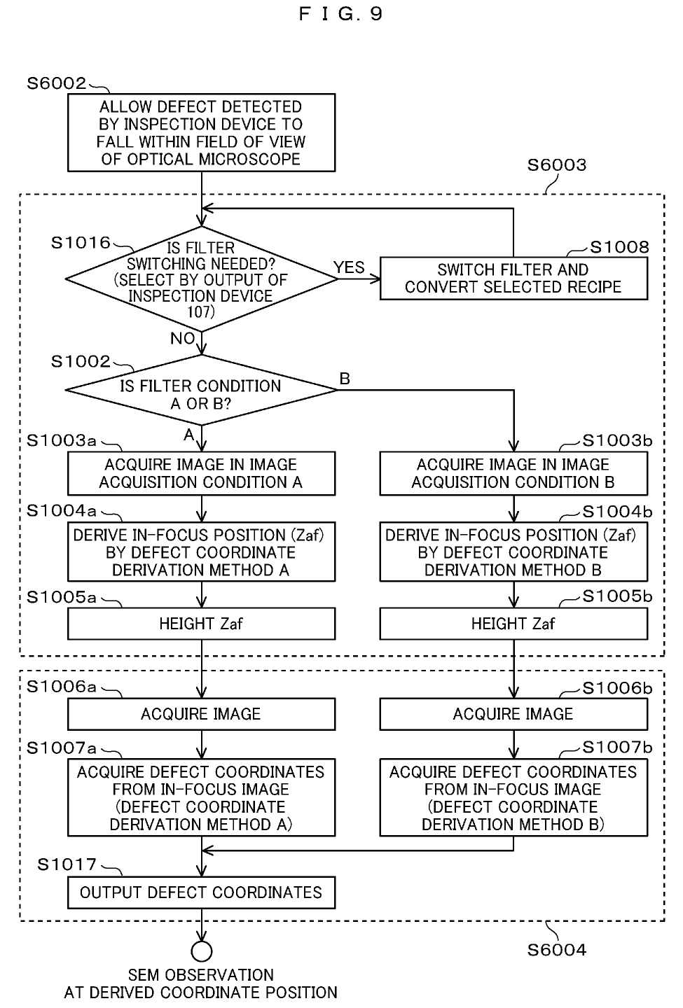

A fourth embodiment of the present invention will be described with reference to FIG. 9. In this embodiment, the configuration of a review device is also basically the same as that described with reference to FIGS. 1 2 in the first embodiment, and thus, the description of the configuration of the device will be omitted.

FIG. 9 is a flowchart up to defect detection by the optical microscope 105 in the review device 100 in the fourth embodiment. The observation target defect is moved into the field of view of the optical microscope (S6002), and the filter condition of the optical microscope is selected on the basis of the output result of the inspection device 107 (S1021). For example, by using the defect size, defect type information, and the like outputted from the inspection device 107, with respect to minute defects requiring highly sensitive detection, a filter having an anisotropic optical characteristic is selected; with respect to defects having a large size, a neutral density filter is selected, and with respect to defects having an intermediate size, no filter or a polarizer is selected.

Among the steps described in FIG. 9, the steps of from S1016 to S1005a and S1005b and S1008 correspond to S6003 of the process of FIG. 4, and the steps of from S1006a and S1006b to S1017 correspond to S6004 of the process of FIG. 4

In this method, the filter condition is selected from the output result of the inspection device 107, and the image acquisition condition and the defect coordinate derivation method are determined according to the selected filter condition, so that the number of parameters set by the user can be reduced, and thus, the method is easy to use.

### Fifth Embodiment

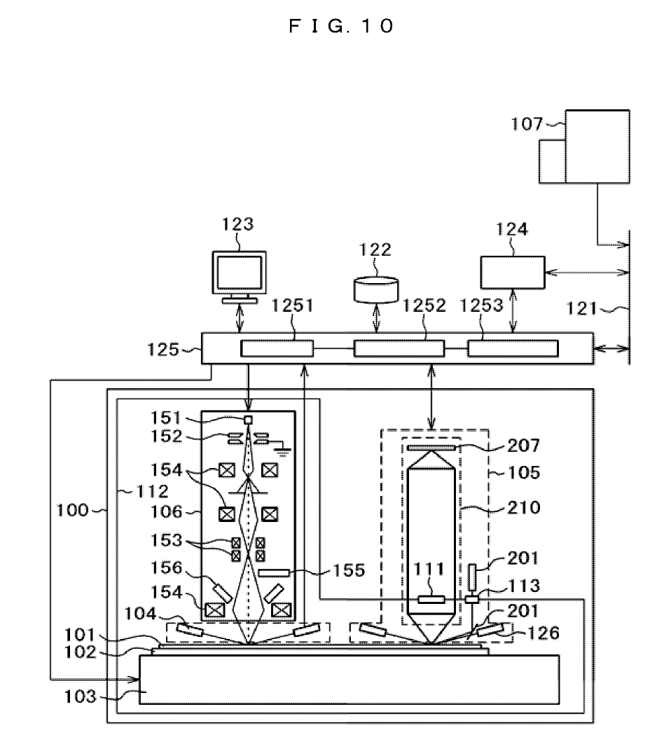

A fifth embodiment of the present invention will be described with reference to FIG. 10. In this embodiment, the configuration of the review device is also basically the same as that described in the first embodiment with reference to FIGS. 1 and 2, but this embodiment is different in that the optical microscope 105 includes a height detector 126. Although it is illustrated that the height detector 126 illustrated in FIG. 10 has the same function as the optical height detector 104 for measuring the height coaxially with the SEM 106, the height detector 126 is not limited thereto. Other height measurement device, for example, a confocal microscope, or a device using a TTL (Through The Lens) method may be used. In addition, in the case where it is difficult to measure the height coaxially with the optical microscope 105 due to the structure (for example, it is difficult to use an oblique-incidence-type height detector because the objective lens has a high NA), the height of the measurable area around the optical axis of the optical microscope 105 may be measured.

In this method, the image acquisition range can be suppressed, and thus, the time required for deriving the defect coordinates can be shortened, so that it is possible to improve the throughput of the SEM observation.

In the first, second, third, fourth, and fifth embodiments, even if the filter conditions are different, the same image acquisition condition and defect coordinate derivation method may be used. For example, with respect to no filter and a polarizer, the same image acquisition condition and defect coordinate derivation method may be used.

Although the invention contrived by the inventors has been specifically described on the basis of the embodiments, the present invention is not limited to the above embodiments, but various modifications can be made within the scope without departing from the spirit of the prevent invention.

### REFERENCE SIGNS LIST

101: sample
102: sample holder
103: stage
104, 126: optical height detector
105: optical microscope
106: electron microscope
107: inspection device
111: vacuum sealing window
112: vacuum tank
121: network
122: library
123: user interface
124: storage device
125: control system

1. A defect observation method of detecting a defect from an image obtained by imaging the defect on a sample with an optical microscope by using positional information of the defect on the sample detected by a different inspection device to correct the positional information of the defect and observing in detail the defect on the sample with a scanning electron microscope (SEM) using the corrected positional information, the defect observation method comprising:
detecting the defect from the image obtained by imaging the defect with the optical microscope to correct the positional information of the defect;
switching a spatially-distributed optical element of a detection optical system of the optical microscope according to the defect to be detected; and
changing an image acquisition condition for acquiring the image of the defect by imaging the defect with the optical microscope and an image processing condition for detecting the defect from the image obtained by imaging the defect with the optical microscope according to a type of the switched spatially-distributed optical element.

2. The defect observation method according to claim 1, wherein the image acquisition condition for acquiring the image of the defect by imaging the defect with the optical microscope and the image processing condition for detecting the defect from the image obtained by imaging the defect with the optical microscope are changed according to whether the switched spatially-distributed optical element is a spatially-distributed optical element having an isotropic optical characteristic or a spatially-distributed optical element having an anisotropic optical characteristic.

3. The defect observation method according to claim 2, wherein in the case of using the spatially-distributed optical element having the isotropic optical characteristic, in comparison with the case of using the spatially-distributed optical element having the anisotropic optical characteristic, the number of images obtained by imaging the sample with the optical microscope by shifting a focus position of the detection optical system in order to align the focus position of the detection optical system to a surface of the sample is small.

4. The defect observation method according to claim 1, wherein positional information of a barycenter of the defect is displayed on a screen to be superimposed on an image including the defect obtained by imaging at an in-focus position of the optical microscope by changing the image acquisition condition for acquiring the image of the defect by imaging the defect with the optical microscope and the image processing condition for detecting the defect from the image obtained by imaging the defect with the optical microscope according to the type of the switched spatially-distributed optical element.

5. The defect observation method according to claim 1, wherein likelihood of coordinates of the defect detected by processing the image of the defect acquired under the image acquisition condition changed according to the type of the spatially-distributed optical element under the image processing condition changed according to the type of the spatially-distributed optical element is determined, and it is determined whether or not the image of the defect is acquired again according to the determined likelihood.

6. A defect observation method of detecting a defect from an image obtained by imaging the defect on a sample with an optical microscope by using positional information of the defect on the sample detected by a different inspection device to correct the positional information of the defect and observing in detail the defect on the sample with a scanning electron microscope (SEM) using the corrected positional information of the defect, the defect observation method comprising:
detecting the defect from the image obtained by imaging the defect with the optical microscope to correct the positional information of the defect; and
performing correcting by using the positional information of the defect obtained by changing an image acquisition condition for acquiring a plurality of images having different focus positions acquired in order to align the focus position of the optical microscope to a surface of the sample and a defect coordinate derivation condition for obtaining coordinates of the defect from the image obtained by imaging the defect with the optical microscope according to an optical characteristic of a spatially-distributed optical element of an detection optical system of the optical microscope.

7. The defect observation method according to claim 6, wherein the image acquisition condition for acquiring a plurality of the images having different focus positions acquired in order to align the focus position of the optical microscope to the surface of the sample and the defect coordinate derivation condition for obtaining coordinates of the defect from the image obtained by imaging the defect with the optical microscope are changed according to whether the spatially-distributed optical element of the detection optical system of the optical microscope has an isotropic optical characteristic or an anisotropic optical characteristic.

8. The defect observation method according to claim 6, wherein an in-focus position to the surface of the sample of the detection optical system is determined by using the image acquired under the image acquisition condition for acquiring a plurality of the images having different focus positions acquired in order to align the focus position of the optical microscope to the surface of the sample according to the optical characteristic of the spatially-distributed optical element of the detection optical system of the optical microscope, the positional information of the defect is acquired by changing defect coordinate derivation condition for obtaining the coordinates of the defect according to the optical characteristic of the spatially-distributed optical element of the detection optical system with respect to the image of the defect imaged at the determined in-focus position, and the positional information of the defect is corrected by comprising the acquired positional information of the defect with the positional information of the defect on the sample detected by the different inspect device.

9. The defect observation method according to claim 8, wherein the image of the defect imaged at the determined in-focus position is acquired by changing the defect coordinate derivation condition for obtaining the coordinates of the defect according to the optical characteristic of the spatially-distributed optical element of the detection optical system, and the positional information of the defect is displayed on a screen to be superimposed.

10. The defect observation method according to claim 6, wherein likelihood of coordinates of the defect detected by processing the image of the defect acquired under the image acquisition condition changed according to the type of the spatially-distributed optical element under the image processing condition changed according to the type of the spatially-distributed optical element is determined, and it is determined whether or not the image of the defect is acquired again according to the determined likelihood.

11. A defect observation device comprising:
an optical microscope unit configured to optically detect a defect on a sample by using positional information of the defect on the sample detected by a different inspection device; and
a scanning microscope (SEM) unit configured to acquire a detailed image of the defect by using the positional information of the defect detected by the optical microscope unit,
wherein the optical microscope unit includes:
an illumination optical system unit configured to irradiate a defect on the sample with illumination light;
a detection optical system unit including a spatially-distributed optical element imaging a surface of the sample irradiated with the illumination light by the illumination optical system unit;
a condition setting unit configured to set an imaging condition for imaging the surface of the sample with the detection optical system and an image processing condition for processing an image of the surface of the sample obtained by imaging the surface of the sample with the detection optical system; and
an image processing unit configured to process the image of the surface of the sample obtained by imaging by the detection optical system unit on the basis of the image processing condition set by the condition setting unit to detect a defect on the sample, and
wherein the condition setting unit changes the condition for imaging the surface of the sample by the detection optical system unit and the image processing condition for processing the image of the surface of the sample by the image processing unit according to a type of the spatially-distributed optical element of the detection optical system unit.

12. The defect observation device according to claim 11, wherein the detection optical system unit includes, as the spatially-distributed optical element, a spatially-distributed optical element having an isotropic optical characteristic and a spatially-distributed optical element having an anisotropic optical characteristic and a switching mechanism switching the spatially-distributed optical element having the isotropic optical characteristic and the spatially-distributed optical element having the anisotropic optical characteristic, and the condition setting unit changes a procedure for aligning a focus of the detection optical system unit to the surface of the sample and a procedure for allowing the imaging process unit to process the image to detection a barycentric position of the defect at the time when the detection optical system unit is switched to the spatially-distributed optical element having the isotropic optical characteristic by the switching mechanism and at the time when the detection optical system unit is switched to the spatially-distributed optical element having the anisotropic optical characteristic by the switching mechanism.

13. The defect observation device according to claim 11, wherein the condition setting unit sets the imaging condition of the detection optical system so that, in comparison with the time when the detection optical system unit is switched to the spatially-distributed optical element having the isotropic optical characteristic by the switching mechanism, at the time when the detection optical system unit is switched to the spatially-distributed optical element having the anisotropic optical characteristic by the switching mechanism, the number of images obtained by imaging the surface of the sample while shifting a height of the focus of the detection optical system unit by one pitch in order to align the focus of the detection optical system unit to the surface of the sample is increased.
